(19) United States
(12) Patent Application Publication
(10) Pub. No.: US 2015/0006940 A1
(43) Pub. Date: Jan. 1, 2015

(54) SERVER POWER PREDICTING APPARATUS AND METHOD USING VIRTUAL MACHINE

(71) Applicant: Electronics and Telecommunications Research Institute, Daejeon-city (KR)

(72) Inventors: Daewon KIM, Daejeon (KR); Sungik Jun, Daejeon (KR); Byeongthaek Oh, Daejeon (KR); Hagyoung Kim, Daejeon (KR)

(73) Assignee: Electronics and Telecommunications Research Institute, Daejeon-city (KR)

(21) Appl. No.: 14/290,133

(22) Filed: May 29, 2014

(30) Foreign Application Priority Data
Jun. 26, 2013 (KR) 10-2013-0073805

(51) Int. Cl. G06F 1/28

(52) U.S. Cl. CPC G06F 1/28
USPC 713/340

(57) ABSTRACT

A server power predicting method apparatus and method using a virtual machine are provided. The server power predicting method includes: calculating an initial power amount of a virtual machine allocated to a server; calculating a power consumption proportion of each component of the virtual machine; calculating a power consumption variation of each component of the virtual machine during a predetermined period of time; calculating total power consumption of the virtual machine based on an initial power amount of the virtual machine, the power consumption proportion of each component of the virtual machine, and the power consumption variation of each component of the virtual machine; and adding the total power consumption of the virtual machine to the initial power amount of the server to predict total power consumption of the server.

This application claims the benefit of Korean Patent Application No. 10-2013-0073805 filed on Jun. 26, 2013, with the Korean Intellectual Property Office, the disclosure of which is incorporated herein by reference.

### BACKGROUND OF THE INVENTION

1. Field of the invention

The present invention relates to a server power predicting apparatus and method using a virtual machine, and more particularly, to a server power predicting apparatus and method using a virtual machine capable of predicting total power consumption of a server by using a power prediction amount calculated through a virtual machine.

2. Discussion of the Related Art

In general, typical methods for obtaining power of an overall server may be divided into a method of calculating power at a hard disk level and a method of using a power calculation model at a simulation level.

The method of calculating power at a hard disk level is a method of calculating a variation of data by using a sensor or a calculating instrument. This method allows for fast and accurate calculation of a variation but it is limited to calculation of only power with respect to a current system and not available to be applied to an analysis method or a power analysis for the future. Also, in order to calculate power consumption in real time with this method, a power calculating sensor should monitor wattage (or an amount of electricity) consumed by a server constantly regardless of an operational state of the server. To this end, the power calculating sensor needs to operate constantly, namely, for 24 hours, all day long. In this case, if power consumption of a server is small and the server is very limitedly used, power consumed by the power calculating sensor for monitoring may be too much to be negligible, rather increasing power consumption. As a related art, Korean Patent Laid-Open Publication No. 10-2011-0070297 discloses a technique entitled “Power Calculating Device and Power Consumption Reducing Method Using the Same”.

Meanwhile, the method of modeling a power calculation model at a simulation level is commonly used because it allows for analysis and prediction using detailed information. However, in many cases, simulation requires an analysis time from one hour to a day, and modification and correction of application software of simulation requires technical knowledge, and in case of redesigning software according to circumstances, performing programming again and analyzing it again may incur a huge amount of time and costs.

### SUMMARY OF THE INVENTION

The present disclosure provides a server power predicting apparatus and method using a virtual machine capable of calculating total power consumption of a virtual machine by using a power consumption proportion of each component of the virtual machine and a power consumption variation, thus quickly predicting a change or progress in server power even without a hard disk for calculating power.

In an aspect, a server power predicting method using a virtual machine may include: calculating an initial power amount of a virtual machine allocated to a server; calculating a power consumption proportion of each component of the virtual machine; calculating a power consumption variation of each component of the virtual machine during a predetermined period of time; calculating total power consumption of the virtual machine based on an initial power amount of the virtual machine, the power consumption proportion of each component of the virtual machine, and the power consumption variation of each component of the virtual machine; and adding the total power consumption of the virtual machine to the initial power amount of the server to predict total power consumption of the server.

In the calculating of an initial power amount of the virtual machine, the initial power amount of the virtual machine may be calculated by the sum of a power amount of the virtual machine in a standby state, a power amount of the virtual machine in a sleep state, and a power amount of the virtual machine in an idle state.

In the calculating of a power consumption proportion of each component of the virtual machine, the components of the virtual machine may include at least one of a central processing unit (CPU), a memory, and a hard disk.

In the calculating of a power consumption proportion of each component of the virtual machine, the power consumption proportion of each component may be a ratio of power consumption of each component of the virtual machine to the total power consumption of the virtual machine at a specific point of time.

The calculating of a power consumption variation of each component of the virtual machine during a predetermined period of time may include: calculating first current power consumption of each component of the virtual machine at a specific point in time; calculating second current power consumption of each component of the virtual machine at a point in time after the lapse of a predetermined time from the specific point in time; and calculating the power consumption variation corresponding to a difference value between the second current power consumption and the first current power consumption of each component of the virtual machine.

In the calculating of a total power consumption of the virtual machine based on an initial power amount of the virtual machine, the power consumption proportion of each component of the virtual machine, and the power consumption variation of each component of the virtual machine, the total power consumption of the virtual machine may be calculated by multiplying each power consumption proportion and each power consumption variation calculated for each component, adding the product values, and subsequently adding the initial power amount to the sum of the product values.

In the adding of the total power consumption of the virtual machine to the initial power amount of the server to predict total power consumption of the server, the initial power amount of the server may be calculated by the sum of a power amount of the server in a standby state, a power amount of the server in a sleep state, and a power amount of the server in an idle state.

In another aspect, a server power predicting apparatus using a virtual machine may include: an initial power amount calculating unit configured to calculate an initial power amount of a virtual machine allocated to a server; a power consumption proportion calculating unit configured to calculate a power consumption proportion of each component of the virtual machine; a power consumption variation calculating unit configured to calculate a power consumption variation of each component of the virtual machine during a predetermined period of time; a total power consumption amount calculating unit configured to calculate total power consumption of the virtual machine based on an initial power amount of the virtual machine, the power consumption proportion of each component of the virtual machine, and the power consumption variation of each component of the virtual machine; and a power predicting unit configured to add the total power consumption of the virtual machine to the initial power amount of the server to predict total power consumption of the server.

The initial power amount calculating unit may calculate the initial power amount of the virtual machine by the sum of a power amount of the virtual machine in a standby state, a power amount of the virtual machine in a sleep state, and a power amount of the virtual machine in an idle state.

The power consumption proportion calculating unit may calculate the power consumption proportion of each component, as a proportion of power consumption of each component of the virtual machine to the total power consumption of the virtual machine.

The power consumption variation calculating unit may include: a first power consumption calculating unit configured to calculate first current power consumption of each component of the virtual machine at a specific point in time; a second power consumption calculating unit configured to calculate second current power consumption of each component of the virtual machine at a point in time after the lapse of a predetermined time from the specific point in time; and a variation calculating unit configured to calculate the power consumption variation corresponding to a difference value between the second current power consumption and the first current power consumption of each component of the virtual machine.

The total power consumption calculating unit may multiply each power consumption proportion and each power consumption variation calculated for each component, add the product values, and subsequently add the initial power amount to the sum of the product values to calculate the total power consumption of the virtual machine.

The power predicting unit may calculate the initial power amount of the server by the sum of a power amount of the server in a standby state, a power amount of the server in a sleep state, and a power amount of the server in an idle state.

In the case of the server power predicting apparatus and method using a virtual machine having the foregoing configurations according to embodiments of the present disclosure, since total power consumption of a server is predicted based on total power consumption of a virtual machine calculated by using a power consumption proportion and a power consumption variation of each component of the virtual machine, a change or progress in power of the overall server may be quickly predicted without using a hard disk for calculating actual power of the server.

### BRIEF DESCRIPTION OF THE DRAWINGS

FIG. 1 is a view illustrating a configuration of a server power predicting apparatus using a virtual machine according to an embodiment of the present disclosure.

FIG. 2 is a view illustrating a detailed configuration of a power consumption variation calculating unit employed in the server power predicting apparatus using a virtual machine according to an embodiment of the present disclosure.

FIG. 3 is a flow chart illustrating a sequential process of a server power predicting method using a virtual machine according to an embodiment of the present disclosure.

FIG. 4 is a view illustrating a process of calculating power consumption variation to in the power server predicting method using a virtual machine according to an embodiment of the present disclosure.

### DETAILED DESCRIPTION OF THE EMBODIMENTS

Embodiments will be described in detail with reference to the accompanying drawings such that they can be easily practiced by those skilled in the art to which the present disclosure pertains. In the drawings, like or similar reference numerals are used for like or similar parts, although they are illustrated in different drawings. Also, in describing the present disclosure, if a detailed explanation for a related known function or construction is considered to unnecessarily divert the gist of the present disclosure, such explanation will be omitted but would be understood by those skilled in the art.

Hereinafter, a server power predicting method using a virtual machine according to an embodiment of the present disclosure will be described in detail with reference to the accompanying drawings.

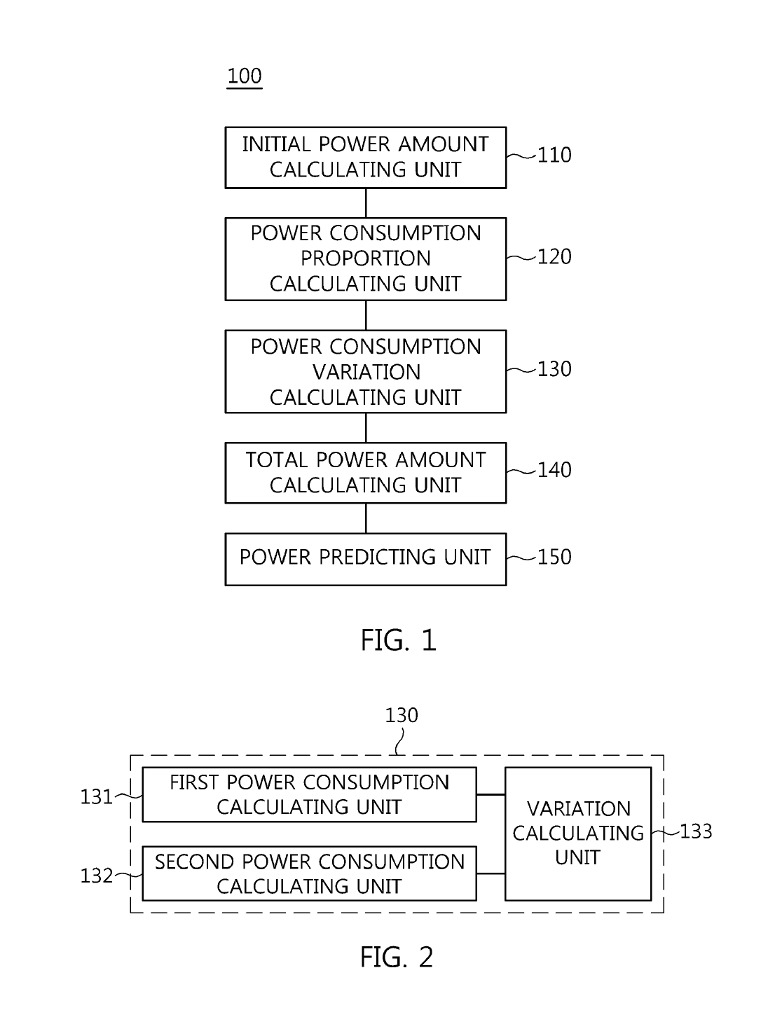

FIG. 1 is a view illustrating a configuration of a server power predicting apparatus using a virtual machine according to an embodiment of the present disclosure, and

FIG. 2 is a view illustrating a detailed configuration of a power consumption variation calculating unit employed in the server power predicting apparatus using a virtual machine according to an embodiment of the present disclosure.

Referring to FIG. 1, a server power predicting apparatus 100 using a virtual machine according to an embodiment of the present disclosure includes an initial power amount calculating unit 110, a power consumption proportion calculating unit 120, a power consumption variation calculating unit 130, a total power consumption calculating unit 140, and a power predicting unit 150.

First, in order to calculate a virtual power amount, the virtual machine according to an embodiment of the present disclosure is allocated to a server in which a type of a central processing unit (CPU), a type or capacity of a memory, or a hard disk configuration are set in advance. Also, a plurality of virtual machines may be allocated to the server.

The initial power amount calculating unit 110 calculates an initial power amount of the virtual machine allocated to the server. The initial power amount calculating unit 110 calculates the initial power amount by the sum of a power amount of the virtual machine in a standby state, a power amount of the virtual machine in a sleep state, and a power amount of the virtual machine in an idle state.

Namely, the initial power amount calculating unit 110 calculates the initial power amount by Equation 1 below.

Pstart,vm(S)=Pstandby,vm+Psleep,vm+Pidle,vm [Equation 1]

Here, Pstart(S) is an initial power amount, Pstandby is a power amount of the virtual machine in a standby state, Psleep is a power amount of the virtual machine in a sleep state, and Pidle is a power amount of the virtual machine in an idle state.

The power consumption proportion calculating unit 120 calculates a power consumption proportion of each component of the virtual machine. Namely, the power consumption proportion calculating unit 120 calculates a power consumption proportion of each component of the virtual machine to total power consumption of the virtual machine for a specific period of time. In this case, like the components of the server, components of the virtual machine include at least any one of a central processing unit (CPU), a memory, and a hard disk. Here, when power consumption of the components of a single virtual machine is measured, approximately 70% or more of total power consumption are concentrated on the CPU, the memory, and the hard disk. Specifically, the CPU consumes the largest amount of power, and the memory and the hard disk follow.

Namely, the power consumption proportion calculating unit 120 calculates power consumption proportions by Equation 2 below. Namely, as expressed by Equation 2, when total power consumption of the virtual machine is measured with a power consumption proportion (α) fixed, power consumption proportion of each component for a specific period of time is calculated. This is the same as obtaining a solution to system of linear equations with three variables.

$$[ \begin{matrix}Ucpu 1 & Umem 1 & Uhdd 1 \\ Ucpu 2 & Umem 2 & Uhdd 2 \\ Ucpu 3 & Umem 3 & Uhdd 3\end{matrix} ] [ \begin{matrix}α cpu \\ α mem \\ α hdd\end{matrix} ] = [ \begin{matrix}Pvm 1 \\ Pvm 2 \\ Pvm 3\end{matrix} ] \qquad \{ Equation 2 ]$$

In this case, Ucpu1, Umem1, and Uhdd1 power consumption variations of each of a CPU, a memory, and a hard disk of a first virtual machine, Ucpu2, Umem2, and Uhdd2 are power consumption variations of each of a CPU, a memory, and a hard disk of a second virtual machine, Ucpu3, Umem3, and Uhdd3 are power consumption variations of each of a CPU, a memory, and a hard disk of a third virtual machine, αcpu, αmem, and αhdd are power consumption portions of the CPU, the memory, and the hard disk, Pvm1 is total power consumption of the first virtual machine, Pvm2 is total power consumption of the second virtual machine, and Pvm3 is total power consumption of the third virtual machine.

The power consumption variation calculating unit 130 calculates a power consumption variation of each component of the virtual machine during a predetermined period of time. To this end, as illustrated in FIG. 2, the power consumption variation calculating unit 130 includes a first power consumption calculating unit 131, a second power consumption calculating unit 132, and a variation calculating unit 133.

The first power consumption calculating unit 131 calculates first current power consumption of each component of the virtual machine at a specific point in time

The second power consumption calculating unit 132 calculates second current power consumption of each component of the virtual machine at a point in time after the lapse of a predetermined time from the specific point in time.

The variation calculating unit 133 calculates a power consumption variation corresponding to a difference value between the second current power consumption and the first current power consumption of each component of the virtual machine.

The total power consumption calculating unit 140 calculates total power consumption of the virtual machine based on an initial power amount of the virtual machine, the power consumption proportion of each component of the virtual machine, and the power consumption variation of each component of the virtual machine.

Namely, the total power consumption calculating unit 140 multiplies each power consumption proportion and each power consumption variation calculated for each component, adds the product values, and subsequently adds the initial power amount of the virtual machine calculated through Equation 1 to the sum of the product values to calculate the total power consumption of the virtual machine.

Namely, the total power consumption calculating unit 140 calculates total power consumption by Equation 3 below.

Pvm(t,S)=Pstart,vm(S)+αcpu·Ucpu(t)+αmem·Umem(t)'αhdd·Uhdd(t) [Equation 3]

Here, Pvm is total power consumption of the virtual machine, Pstart,vm(S) is an initial power amount of the virtual machine, αcpu·Ucpu(t) is the product of a power consumption proportion of the CPU among components of the virtual machine and consumption power variation thereof at time t, αmem·Umem(t) is the product of a power consumption proportion of the memory among the components of the virtual machine and power consumption variation at time t, and αhdd·Uhdd(t) is the product of a power consumption proportion of the hard disk among the components of the virtual machine and a power consumption variation thereof at time t.

The power predicting unit 150 predicts total power consumption of the server by adding the initial power amount of the server and the total power consumption of the virtual machine.

Namely, the power predicting unit 150 calculates total power consumption by Equation 4 below.

Pserver(t,S)=Pstart,server(S)+Pvm1(t)+Pvm2(t)+ . . . +Pvmn(t) [Equation 4]

Here, Pserver is total power consumption of the server, Pstart,server(S) is an initial power amount of the server, Pvm1 is total power consumption of the first virtual machine at time 5, pvm2 is total power consumption of the second virtual machine at time 5, Pvm3 is total power consumption of the third virtual machine at time 5, and Pvmn is total power consumption of nth virtual machine at time t.

Meanwhile, the power predicting unit 150 calculates the initial power amount of the server by the sum of a power amount of the server in a standby state, a power amount of the server in a sleep state, and a power amount of the server in an idle state.

Namely, the power predicting unit 150 calculates the initial power amount of the server by Equation 5 below.

Pstart,server(S)=Pstandby,server+Psleep,server+Pidle,server [Equation 5]

Here, Pstart,server(S) is an initial power amount, Pstandby,server is a power amount of the server in a standby state, Psleep,server is a power amount of the server in a sleep state, and Pidle,server is a power amount of the server in an idle state.

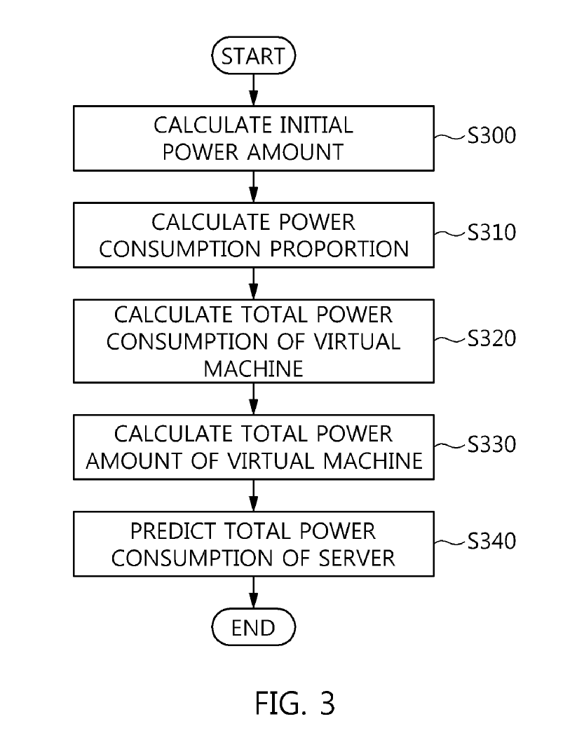

FIG. 3 is a flow chart illustrating a sequential process of a server power predicting method using a virtual machine according to an embodiment of the present disclosure.

Referring to FIG. 3, the server power predicting method using a virtual machine according to the embodiment of the present disclosure uses the server power predicting apparatus using a virtual machine as described above, so a redundant description will be omitted.

First, an initial power amount of the virtual machine allocated to the server is calculated (S300). The initial power amount in operation S300 is calculated by the sum of a power amount of the virtual machine in a standby state, a power amount of the virtual machine in a sleep state, and a power amount of the virtual machine in an idle state.

Next, a power consumption proportion of each component of the virtual machine (S310). The power consumption proportion of each component of the virtual machine in operation S310 is calculated as a ratio of power consumption of each component of the virtual machine to total power consumption of the virtual machine at a specific point of time.

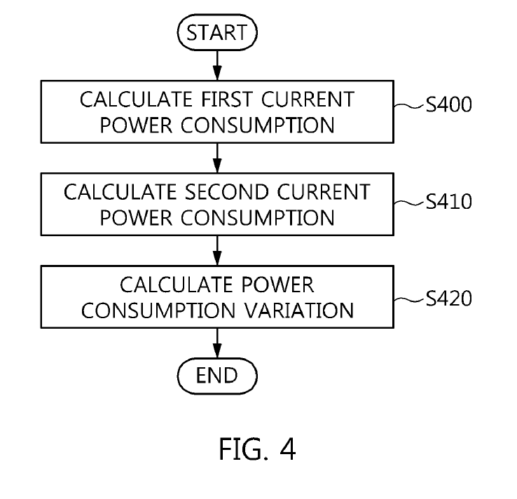

Thereafter, a power consumption variation of each component of the virtual machine during a predetermined period of time (S320). A method of calculating a power consumption variation in operation S320 will be described in detail with reference to FIG. 4 hereinafter.

Subsequently, total power consumption of the virtual machine is calculated based on the initial power amount of the virtual machine, the power consumption proportion of each component of the virtual machine, and the power consumption variation of each component of the virtual machine (S330). In operation S330, the total power consumption of the virtual machine is calculated by multiplying each power consumption proportion and each power consumption variation calculated for each component, adding the product values, and subsequently adding the initial power amount of the virtual machine to the sum of the product values.

The total power consumption of the virtual machine is added to the initial power amount of the server to predict total power consumption of the server (S340). In operation S340, the total power consumption of the server is predicted by adding the total power consumption of the virtual machine to the initial power amount of the server. In this case, the power predicting unit 150 calculates the initial power amount of the server by the sum of a power amount of the server in a standby state, a power amount of the server in a sleep state, and a power amount of the server in an idle state.

FIG. 4 is a view illustrating a process of calculating power consumption variation in the power server predicting method using a virtual machine according to an embodiment of the present disclosure.

Referring to FIG. 4, in the process of calculating a power consumption variation of each component, first, first current power consumption of each component of the virtual machine at a specific point in time is calculated (S400).

Next, second current power consumption of each component of the virtual machine at a point in time after the lapse of a predetermined time from the specific point in time is calculated (S410).

Thereafter, a power consumption variation corresponding to a difference value between the second current power consumption and the first current power consumption of each component of the virtual machine is calculated (S420).

In this manner, In the case of the server power predicting apparatus and method using a virtual machine having the foregoing configurations according to embodiments of the present disclosure, since total power consumption of a server is predicted based on total power consumption of a virtual machine calculated by using a power consumption proportion and a power consumption variation of each component of the virtual machine, a change or progress in power of the overall server may be quickly predicted without using a hard disk for calculating actual power of the server.

The foregoing embodiments and advantages are merely exemplary and are not to be considered as limiting the present disclosure. it will be apparent to those skilled in the art that modifications and variations can be made without departing from the spirit and scope of the invention. This description is intended to be illustrative, and not to limit the scope of the claims. Also, although an embodiment has not been described in the above disclosure, it should be extensively construed within the scope of the technical concept defined in the claims. And, various changes and modifications that fall within the scope of the claims, or equivalents of such scope are therefore intended to be embraced by the appended claims.

What is claimed is:

1. A server power predicting method using a virtual machine, the method comprising:
calculating an initial power amount of a virtual machine allocated to a server;
calculating a power consumption proportion of each component of the virtual machine;
calculating a power consumption variation of each component of the virtual machine during a predetermined period of time;
calculating total power consumption of the virtual machine based on an initial power amount of the virtual machine, the power consumption proportion of each component of the virtual machine, and the power consumption variation of each component of the virtual machine; and
adding the total power consumption of the virtual machine to the initial power amount of the server to predict total power consumption of the server.

2. The server power predicting method of claim 1, wherein, in the calculating of an initial power amount of the virtual machine, the initial power amount of the virtual machine is calculated by the sum of a power amount of the virtual machine in a standby state, a power amount of the virtual machine in a sleep state, and a power amount of the virtual machine in an idle state.

3. The server power predicting method of claim 1, wherein, in the calculating of a power consumption proportion of each component of the virtual machine, the components of the virtual machine include at least one of a central processing unit (CPU), a memory, and a hard disk.

4. The server power predicting method of claim 1, wherein, in the calculating of a power consumption proportion of each component of the virtual machine, the power consumption proportion of each component is a ratio of power consumption of each component of the virtual machine to the total power consumption of the virtual machine at a specific point of time.

5. The server power predicting method of claim 1, wherein the calculating of a power consumption variation of each component of the virtual machine during a predetermined period of time comprises:
calculating first current power consumption of each component of the virtual machine at a specific point in time;
calculating second current power consumption of each component of the virtual machine at a point in time after the lapse of a predetermined time from the specific point in time; and
calculating the power consumption variation corresponding to a difference value between the second current power consumption and the first current power consumption of each component of the virtual machine.

6. The server power predicting method of claim 1, wherein, in the calculating of a total power consumption of the virtual machine based on an initial power amount of the virtual machine, the power consumption proportion of each component of the virtual machine, and the power consumption variation of each component of the virtual machine, the total power consumption of the virtual machine is calculated by multiplying each power consumption proportion and each power consumption variation calculated for each component, adding the product values, and subsequently adding the initial power amount to the sum of the product values.

7. The server power predicting method of claim 1, wherein, in the adding of the total power consumption of the virtual machine to the initial power amount of the server to predict total power consumption of the server, the initial power amount of the server is calculated by the sum of a power amount of the server in a standby state, a power amount of the server in a sleep state, and a power amount of the server in an idle state.

8. A server power predicting apparatus using a virtual machine, the apparatus comprising:
an initial power amount calculating unit configured to calculate an initial power amount of a virtual machine allocated to a server;
a power consumption proportion calculating unit configured to calculate a power consumption proportion of each component of the virtual machine;
a power consumption variation calculating unit configured to calculate a power consumption variation of each component of the virtual machine during a predetermined period of time;
a total power consumption amount calculating unit configured to calculate total power consumption of the virtual machine based on an initial power amount of the virtual machine, the power consumption proportion of each component of the virtual machine, and the power consumption variation of each component of the virtual machine; and
a power predicting unit configured to add the total power consumption of the virtual machine to the initial power amount of the server to predict total power consumption of the server.

9. The server power predicting apparatus of claim 8, wherein the initial power amount calculating unit calculates the initial power amount of the virtual machine by the sum of a power amount of the virtual machine in a standby state, a power amount of the virtual machine in a sleep state, and a power amount of the virtual machine in an idle state.

10. The server power predicting apparatus of claim 8, wherein the power consumption proportion calculating unit calculates the power consumption proportion of each component, as a proportion of power consumption of each component of the virtual machine to the total power consumption of the virtual machine.

11. The server power predicting apparatus of claim 8, wherein the power consumption variation calculating unit comprises:
a first power consumption calculating unit configured to calculate first current power consumption of each component of the virtual machine at a specific point in time;
a second power consumption calculating unit configured to calculate second current power consumption of each component of the virtual machine at a point in time after the lapse of a predetermined time from the specific point in time; and
a variation calculating unit configured to calculate the power consumption variation corresponding to a difference value between the second current power consumption and the first current power consumption of each component of the virtual machine.

12. The server power predicting apparatus of claim 8, wherein the total power consumption calculating unit multiplies each power consumption proportion and each power consumption variation calculated for each component, adds the product values, and subsequently adds the initial power amount to the sum of the product values to calculate the total power consumption of the virtual machine.

13. The server power predicting apparatus of claim 8, wherein the power predicting unit calculates the initial power amount of the server by the sum of a power amount of the server in a standby state, a power amount of the server in a sleep state, and a power amount of the server in an idle state.
